(19) United States
(12) Patent Application Publication
(10) Pub. No.: US 2023/0407791 A1
(43) Pub. Date: Dec. 21, 2023

(54) COUNTERCURRENT HEAT EXCHANGER FOR A TURBOMACHINE, TURBOMACHINE, AND METHOD FOR MANUFACTURING THE EXCHANGER

(71) Applicant: SAFRAN, Paris (FR)

(72) Inventors: Ephraïm TOUBIANA, Moissy-Cramayel (FR); Fabien DESARNAUD, Moissy-Cramayel (FR); Frédéric LAURENSAN, Moissy-Cramayel (FR)

(73) Assignee: SAFRAN, Paris (FR)

(21) Appl. No.: 18/248,290

(22) PCT Filed: Oct. 7, 2021
(86) PCT No.: PCT/FR2021/051741

§ 371 Date: Apr. 7, 2023

(30) Foreign Application Priority Data
Oct. 8, 2020 (FR) 2010282

(51) Int. Cl. F02C 7/141; F28D 1/047; F28F 9/02

(52) U.S. Cl. CPC F02C 7/141; F28D 1/0476; F28F 9/0275; B33Y 10/00

(57) ABSTRACT

A counter-current heat exchanger for a turbomachine comprising a first and a second circuit, the first and the second circuit being respectively configured to receive a first gas flow and a second gas flow, each circuit including a secondary inlet manifold, an exchanging part and a secondary outlet manifold; the exchanging parts of the first circuit and of the second circuit being delimited by exchange walls configured to direct the first and the second gas flow along a first direction; and wherein the secondary inlet manifold and the secondary outlet manifold of the first circuit extend along a second direction substantially perpendicular to the first direction, and open onto a same face of the exchanger.

### CROSS-REFERENCE TO RELATED APPLICATIONS

This is a National Stage Application under 35 U.S.C. § 371 of International Application No. PCT/FR2021/051741, filed Oct. 7, 2021, now published as WO 2022/074339 A1, which claims priority to French Patent Application No. 20 10282, filed on Oct. 8, 2020, the entireties of which are incorporated herein by reference.

### TECHNICAL FIELD

This summary relates to a gas-gas heat exchanger for a turbomachine, in particular a counter-current heat exchanger.

### PRIOR ART

A counter-current gas-gas heat exchanger for a turbomachine is known making it possible to heat the gas of the primary flow path leaving the high-pressure compressor by the gas of the primary flow path leaving the low-pressure turbine, making it possible to supply the environmental control system of the cabin of an aircraft, or else making it possible to maintain different systems of the aircraft within their operating temperature range, for example to ensure compliance with mechanical tolerance values.

However, it is desirable to increase the efficiency and reliability and/or reduce the bulk of this type of exchanger.

### SUMMARY OF THE INVENTION

The aim of this summary is to at least partly remedy these drawbacks.

For this purpose, this summary relates to a counter-current heat exchanger for a turbomachine comprising a first and a second circuit, the first and the second circuit being respectively configured to receive a first gas flow and a second gas flow, each circuit including a secondary inlet manifold, an exchanging part and a secondary outlet manifold; the exchanging parts of the first circuit and of the second circuit being delimited by exchange walls configured to direct the first and the second gas flow along a first direction; and the secondary inlet manifold and the secondary outlet manifold of the first circuit extend along a second direction substantially perpendicular to the first direction, and open onto a same face of the exchanger.

It will be understood that the first circuit and/or the second circuit can include more than one secondary inlet manifold and/or more than one secondary outlet manifold.

Owing to the structure of the exchanger having a first circuit with secondary inlet and outlet manifolds opening onto a same face of the exchanger, it is possible to make a more compact exchanger, easier to incorporate into a turbomachine. This also makes it possible to reduce a forward surface of the exchanger, as well as an exchange length, and thus reduce the weight and bulk of the exchanger at a given level of performance.

In certain embodiments, the heat exchanger has dimensions substantially equivalent along the three dimensions of space, which makes it possible to limit load losses by reducing the length of the circuits and by reducing edge effects. This also makes it possible to improve the homogeneity of the flow of the gas flows, which can moreover be embodied with a reduced number of exchange stages between the two circuits, thus reducing the risk of poor distribution of the gas. Finally, a more homogenous distribution of the flows of hot and cold gas can, for a given performance, improve the thermomechanical resistance of the exchanger.

It will be understood that since the first and second gas flows are directed along a first direction, the exchanger is a counter-current exchanger. It will also be understood that since the first flow is directed along a first direction, the first flow enters into the exchanging parts via a first face and leaves the exchanging parts via a second face, opposite the first face along the first direction, the exchanging parts being sandwiched between the first face and the second face. Conversely, the second flow enters via the second face of the exchanging parts and leaves via the first face.

In addition, this structure is particularly suited to additive manufacturing, for example by powder bed selective fusion.

By way of non-limiting example, the first circuit can include at least two secondary inlet manifolds and at least two secondary outlet manifolds.

In certain embodiments, the secondary inlet manifold and the secondary outlet manifold of the first circuit respectively open into a main inlet manifold and a main outlet manifold.

These main inlet and outlet manifolds make it possible to respectively distribute the first gas flow toward the secondary inlet manifold and to collect the first gas flow from the secondary outlet manifold.

In certain embodiments, the first circuit comprises at least a second secondary inlet manifold and/or a second secondary outlet manifold, the main corresponding manifold among the main inlet manifold and the main outlet manifold comprises a primary duct and at least two auxiliary ducts meeting in the primary duct, each secondary inlet manifold and/or each secondary outlet manifold being connected to an auxiliary duct.

The multiple secondary inlet or outlet manifolds allow better control of the first gas flow in the first circuit, further improving the homogeneity of the flow and thus the thermomechanical resistance of the exchanger.

In certain embodiments, at least one of the secondary inlet and/or outlet manifolds of the first circuit can have a different section from the other secondary manifolds. The secondary inlet or outlet manifolds can also be disposed such that at least two adjacent secondary collectors have a different spacing from a spacing between the other secondary manifolds.

The control of the spacing and sections of the secondary manifolds allows an additional control of the homogeneity of flow of the flow in the exchanger and of the thermomechanical resistance of the exchanger.

In certain embodiments, the second circuit comprises at least one secondary inlet manifold and/or one second secondary outlet manifold.

The multiple secondary inlet or outlet manifolds allow better control of the second gas flow through the second circuit, further improving the homogeneity of the flow and thus the thermomechanical resistance of the exchanger.

In certain embodiments, the first circuit comprises a plurality of secondary inlet manifolds and a plurality of secondary outlet manifolds, configured such that at least one secondary inlet manifold communicates with at least two secondary outlet manifolds.

This structure makes it possible to optimize the circulation of the first gas flow inside the first circuit.

In certain embodiments, the second circuit comprises a plurality of secondary inlet manifolds and a plurality of secondary outlet manifolds, configured such that at least one secondary inlet manifold communicates with at least two secondary outlet manifolds.

This structure makes it possible to optimize the circulation of the second gas flow inside the second circuit.

In certain embodiments, the secondary inlet manifold and the secondary outlet manifold of the second circuit are respectively configured so that the directions of flow of the second gas flow at the inlet and the outlet of the second circuit are substantially along the first direction.

Maintaining the direction of flow of the second circuit substantially along the first direction makes it possible to reduce load losses of the second gas flow traversing the exchanger.

In certain embodiments, at least one of the secondary inlet and outlet manifolds of the second circuit has a V-shaped section in a section along a plane orthogonal to the second direction.

This V-shaped section makes it possible to improve the distribution of the second gas flow in the exchanging part and the collection of the second gas flow of the exchanging part while reducing load losses.

In certain embodiments, at least one of the secondary inlet and outlet manifolds of the first circuit has a V-shaped section in a section along a plane orthogonal to the second direction.

This V-shaped section makes it possible to improve the distribution of the first gas flow in the exchanging part and the collection of the first gas flow of the exchanging part while reducing load losses.

In certain embodiments, walls of the V-shaped section have an angle with the first direction less than 45°, preferably less than 30°.

Such an angle makes it possible to limit the deflection of the second gas flow at the inlet and outlet of the exchange walls, and to reduce load losses by comparison with known solutions having angles near 90°.

In certain embodiments, the exchange walls comprise fins.

The fins make it possible to increase the exchange surface and thus improve the performance of the exchanger. The fins moreover allow better control of the gas flows within the exchanging parts, and thus further improve the distribution of the gas. The fins also improve the thermomechanical resistance of the exchange in the event of high-pressure gas flows.

This summary also relates to a turbojet engine comprising an exchanger as previously defined.

In certain embodiments, the first circuit is connected to a compressor and the second circuit is connected to a turbine.

A turbojet engine equipped with such an exchanger has the advantage of extracting heat from the gas in the turbine (after combustion) to transmit it to the gas in the compressor (before combustion), and thus increase the combustion temperature and therefore the thermal efficiency of the turbojet engine.

This summary also relates to a method for fabricating an exchanger as previously defined, the exchanger being produced by a manufacturing method comprising at least one step of powder bed additive manufacturing.

Since gas-gas heat exchanger is produced by an additive manufacturing method, for example a powder bed laser fusion method, it is possible to adapt the shape of the counter-current heat exchanger to the volume and shape of the space available in the turbomachine. In particular, the structure of such a heat exchanger allows a design by additive manufacturing by limiting reliance on supporting parts. This manufacturing method is moreover easier to implement in relation to conventional brazing manufacturing methods.

In this summary, the term “direction” is used for a non-oriented straight line, and the term “orientation” is used to define an orientation; the terms “inlet” and “outlet” are used in relation to the direction of circulation of the gas; it should be understood that a duct or manifold “extends” along a direction when it allows the circulation of the gas in this direction, independently of the shape of the section and the dimensions in other directions.

### BRIEF DESCRIPTION OF THE DRAWINGS

Other features and advantages of the subject of this summary will become apparent from the following description of embodiments, given by way of non-limiting example, with reference to the appended figures.

FIG. 1 is a section view of a turbomachine comprising a counter-current heat exchanger.

FIG. 2 is a schematic perspective view of a counter-current heat exchanger.

FIG. 3 is a schematic lateral view of an exchanger.

FIG. 4 is a schematic section view along the section plane IV-IV of FIG. 2.

FIG. 5 is a section view along the section plane V-V of FIG. 2.

FIG. 6 is a schematic partial section view, similar to FIG. 5, of a second embodiment of a counter-current heat exchanger.

### DESCRIPTION OF THE EMBODIMENTS

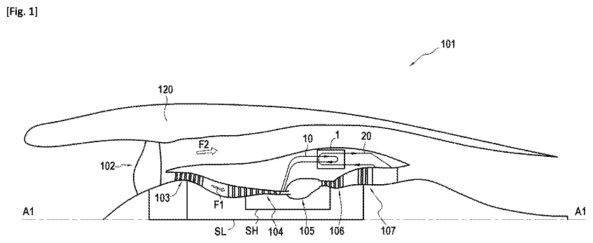

FIG. 1 shows, in half-section along a vertical plane passing through its centerline A1-A1, a turbomachine 101 equipped with a counter-current heat exchanger 1, hereinafter referred to as “exchanger”.

The turbomachine 101 comprises, from upstream to downstream along the circulation of the air flow, a fan 102, a low-pressure compressor 103 (also known as a “booster”), a high-pressure compressor 104, a combustion chamber 105, a high-pressure turbine 106, and a low-pressure turbine 107. These different elements are installed inside a pod 120, in such a way as to obtain a propulsive assembly comprising the pod 120 and the turbomachine 101.

Downstream of the fan 102, the air flow is divided into a first air flow part (also known as primary flow) F1 passing through the low-pressure compressor 103, and a second air flow part (also known as secondary flow) F2 flowing in bypass around the low-pressure compressor 103.

The fan 102 and the low-pressure compressor 103 are driven by the low-pressure turbine 107 via a main low-pressure shaft SL, while the high-pressure compressor 104 is driven by the high-pressure turbine 106 via a main high-pressure shaft SH. The main low-pressure shaft SL extends typically inside the main high-pressure shaft SH.

As mentioned above, the turbomachine 101 is a turbomachine equipped with an exchanger 1. As illustrated very schematically in FIG. 1, such an exchanger 1 is supplied, via an intake duct (not shown) with compressed air leaving the high-pressure compressor 104, this flow forming a first gas flow 10. This compressed air is heated inside the exchanger 1 by the hot gas leaving the low-pressure turbine 107, forming a second gas flow 20, then is sent in the direction of the combustion chamber 105 via a return duct (not shown). The presence of the exchanger 1 has the advantage of reducing the fuel consumption (and therefore improving the thermal efficiency) of the turbomachine 101, since the air entering the combustion chamber 105 has already been preheated by the hot gas leaving the low-pressure turbine 107.

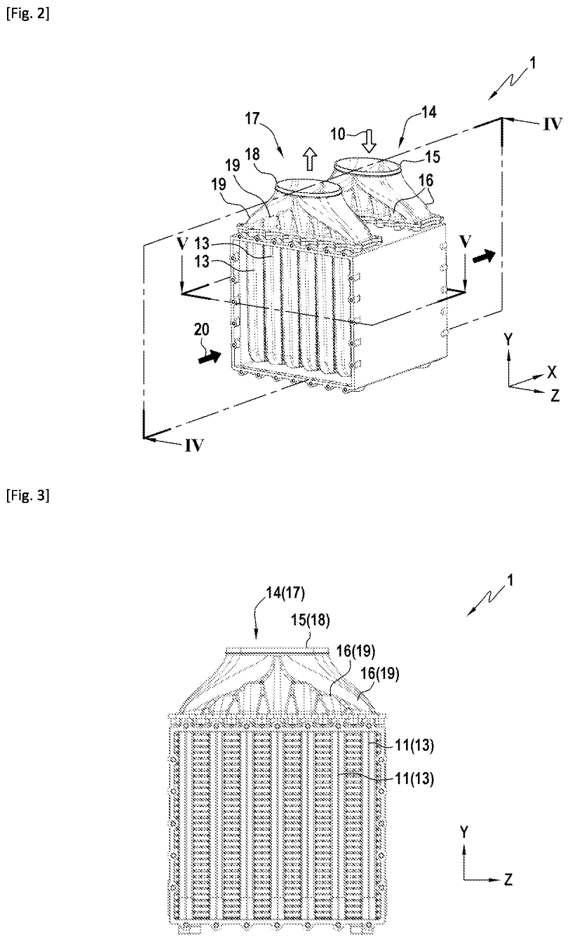

In an embodiment, the exchanger 1 can for example have a substantially cubic or rectangular parallelepipedal shape, as shown in FIG. 2. In the embodiment of FIGS. 2 to 6, the exchanger 1 is shown in an orthonormal frame of reference XYZ formed by the first direction X, the second direction Y and the third direction Z.

On FIGS. 2 to 6, the arrows with no fill schematically indicate the local direction of circulation of the first gas flow 10 through the exchanger 1 and the arrows with a solid fill schematically indicate the local direction of circulation of the second gas flow 20 through the exchanger 1.

For the sake of ease of reading, the reference numbers of the elements present in large numbers (for example auxiliary ducts 16, 19) are not shown for each element.

In general, the exchanger 1 comprises a first gas circuit receiving the first gas flow 10, and a second gas circuit receiving the second gas flow 20.

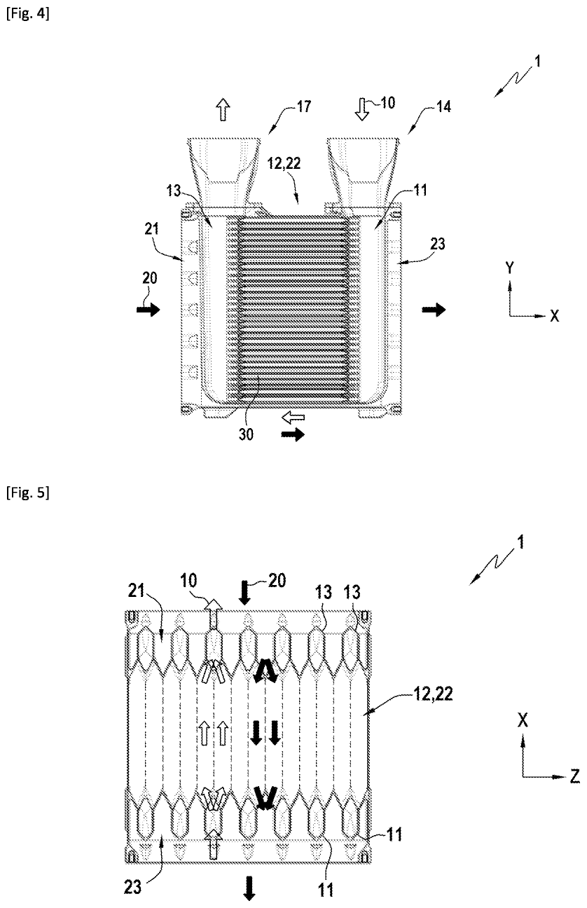

FIGS. 3 and 4 schematically represent two views of the exchanger 1 along two perpendicular directions, FIG. 4 having a section view along the section plane IV-IV of FIG. 2.

In the embodiment of FIGS. 2 to 4, the first gas circuit has a main inlet manifold 14, several secondary inlet manifolds 11, an exchanging part 12, several secondary outlet manifolds 13 and a main outlet manifold 17. In the first circuit, the first flow 10 enters the exchanger 1 via the main inlet manifold 14, then penetrates the secondary inlet manifolds 11 where the first flow 10 is distributed in the exchanging parts 12 of the first circuit. The first flow 10 is then collected in the secondary outlet manifolds 13 and leaves the exchanger 1 via the main outlet manifold 17.

The main inlet 14 and outlet 17 manifolds make it possible to limit the load losses at the inlet and outlet of the exchanger 1.

In the embodiment of FIGS. 2 to 6 and as shown in FIGS. 2 to 4, the second gas circuit shows several secondary inlet manifolds 21, an exchanging part 22 and several secondary outlet manifolds 23. The second flow 20 enters the exchanger 1 via the secondary inlet manifolds 21 where the second flow 20 is distributed in the exchanging parts 22 of the second circuit. The second flow 20 is then collected in the secondary outlet manifolds 23 and leaves the exchanger 1.

The first and second gas circuit do not communicate with one another, such that the gas flows 10, 20 do not mix, but exchange walls 30 disposed between the exchanging parts 12, 22 of the first and of the second circuit promote thermal exchanges between the first and second gas flows 10, 20, and make it possible to direct the first and second gas flows 10, 20 along the first direction X.

In particular, the exchanger 1 is a counter-current heat exchanger 1, i.e. in the exchanging parts 12, 22 of the first and of the second circuit, the two gas flows 10, 20 circulate substantially along one and the same direction, but in opposite orientations.

The second circuit extends substantially along the first direction X, such that the directions of flow of the second gas flow 20 at the inlet and at the outlet of the second circuit are along the first direction X.

The secondary inlet 11 and outlet 13 manifolds of the first circuit extend along the second direction Y substantially perpendicular to the first direction X and open onto a same face of the exchanger 1. The secondary inlet 11 and outlet 13 manifolds of the first circuit, which extend along the second direction Y, are moreover connected to the exchanging parts 12 of the first circuit, which extend along the first direction X, and thus each have an elbow.

The elbows of the secondary inlet manifolds 11 are located at the connections between the inlet ducts 11 and the exchanging parts 12. The elbows of the secondary inlet manifolds 11 are used to redirect the flow entering the first circuit along the second direction Y, toward the exchanging parts 12 of the first circuit, along the first direction X.

The elbows of the secondary outlet manifolds 13 are located at the connections between the secondary outlet manifolds 13 and the exchanging parts 12. The elbows of the secondary outlet manifolds 13 are used to redirect the flow coming from the exchanging parts 12 of the first circuit, along the first direction X, toward the outlet of the first circuit by means of the secondary outlet manifolds 13 extending substantially along the second direction Y.

In particular, in the embodiment of FIGS. 2 to 5, the secondary inlet 11 and outlet 13 manifolds of the first circuit are seven in number. However, this number is given by way of non-limiting example. The exchanger 1 can have at least one secondary inlet manifold 11, preferably at least two secondary inlet manifolds 11. The exchanger can have at least one secondary outlet manifold 13, preferably at least two secondary outlet manifolds 13. It will be understood that the first circuit could comprise a different number of secondary inlet manifolds 11 and secondary outlet manifolds 13. Note also, without limitation, that the secondary inlet 11 and outlet 13 manifolds of the first circuit have sections in a section plane XZ, perpendicular to the second direction Y, substantially constant along the second direction Y, except for the elbows.

Note that the secondary inlet 11 and outlet 13 manifolds have sections in a section plane XZ, perpendicular to the second direction Y, which are identical and that the secondary inlet 11 and outlet 13 manifolds are spaced apart from one another by one and the same distance along the third direction Z, perpendicular to the first direction X and to the second direction Y. It will be understood that at least one of the secondary inlet 11 and/or outlet 13 manifolds could have a different section. It will be understood that at least one of the secondary inlet 11 and/or outlet 13 manifolds could be spaced apart from the adjacent duct by a different distance than that between the other ducts.

In the embodiment of FIGS. 2 to 5, the secondary inlet 21 and outlet 23 manifolds of the second circuit are eight in number. However, this number is given by way of non-limiting example. The exchanger 1 can have at least one secondary inlet manifold 21, preferably at least two secondary inlet manifolds 21. The exchanger 1 can have at least one secondary outlet manifold 23, preferably at least two secondary outlet manifolds 23. It will be understood that the second circuit could comprise a different number of secondary inlet manifolds 21 and secondary outlet manifolds 23.

Note that the secondary inlet 21 and outlet 23 manifolds of the second circuit at the ends of the exchanger 1 do not have the same width along the third direction Z as the intermediate secondary inlet 21 and outlet 23 manifolds and that the secondary inlet 21 and outlet 23 manifolds of the second circuit are spaced apart from one another by one and the same distance along the third direction Z.

In the embodiment of FIGS. 2 to 5, the secondary inlet 21 and outlet 23 manifolds of the second circuit correspond to the openings respectively formed between the secondary outlet manifolds 13 and the secondary inlet manifolds 11. It will be understood that the second circuit can however comprise secondary inlet 21 and outlet 23 manifolds protruding outwards from the exchanger.

In the embodiment of FIGS. 2 to 6 and as shown in FIGS. 2 to 4, the main inlet manifold 14 comprises a primary inlet duct 15 and seven auxiliary inlet ducts 16 meeting in the primary inlet duct 15. The number of auxiliary inlet ducts 16 then corresponds to the number of secondary inlet manifolds 11, such that each inlet duct is connected to an auxiliary inlet duct 16. The number of auxiliary inlet ducts 16 is given by way of non-limiting example.

In the embodiment of FIGS. 2 to 6 and as shown in FIGS. 2 to 4, the main outlet manifold 17 comprises a primary outlet duct 18 and seven auxiliary outlet ducts 19 meeting in the primary outlet duct 18. The number of auxiliary outlet ducts 19 then corresponds to the number of secondary outlet manifolds 13, such that each secondary outlet manifold 13 is connected to an auxiliary outlet duct 19. The number of auxiliary outlet ducts 19 is given by way of non-limiting example.

It will be understood that the auxiliary ducts 16, 19 can be independently implemented on the main inlet manifold 14 and/or the main outlet manifold 17.

It will be further understood that while the second circuit is not shown with a main manifold, such an embodiment is not excluded, any duct connected to the second circuit then having the function of main manifold.

FIG. 5 is in section view along the section plane V-V of FIG. 2.

The dotted lines schematically represent the extension of the exchanging parts 12, 22 substantially along the first direction X seen in the section plane V-V, and examples of corresponding trajectories of gas flows 10, 20 have been shown.

In particular, it is understood that the exchange walls 30 delimiting the exchanging parts 12, 22 can form a dense mesh and/or have fins or any structure known to those skilled in the art making it possible to increase the exchange surface and provide control of the gas flows in the exchanging parts 12, 22.

It should be noted that the representation of the flows are projections into the plane of FIG. 5 for explanatory purposes. In particular, the first gas flow 10 is shown entering and leaving in the first direction X, but in the embodiment described in FIG. 5, the first gas flow 10 enter and leaves from the first circuit along the second direction Y perpendicular to the direction of the plane XZ.

In the section plane of FIG. 5, i.e. a plane normal to the second direction Y and passing through the exchanger 1 and which is therefore parallel to the plane of FIG. 5, the secondary inlet 11 and outlet 13 manifolds of the first circuit have a V-shaped section, and the secondary inlet 21 and outlet 23 manifolds of thesecond circuit have a V-shaped section. The secondary inlet manifolds 11 of the first circuit and the outlet ducts 23 of the second circuit then form a W-shaped structure. In the same way, the secondary inlet manifolds 21 of the second circuit and the secondary outlet manifolds 13 of the first circuit form a W-shaped structure.

In particular, the walls of the V-shaped section have an angle with the first direction X less than 45°, preferably less than 30°.

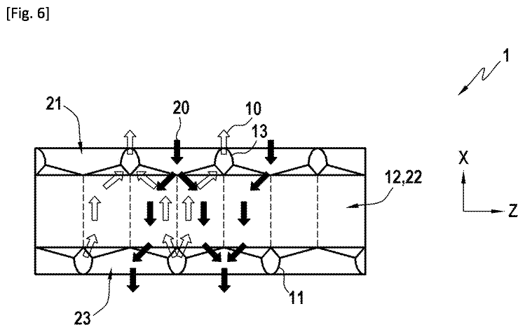

FIG. 6 shows a second embodiment, which is a variation of the first embodiment shown in FIG. 5. FIG. 6 is a section view similar to the section view of FIG. 5. For this purpose, FIG. 6 is a schematic view showing a modification of the embodiment of FIG. 5, wherein the dotted lines schematically show the extension of the exchanging parts 12, 22 substantially along the direction X seen in the section view V-V. This second embodiment is similar to the first embodiment.

In the embodiment of FIG. 6, the secondary inlet 11 and outlet 13 manifolds of the first circuit are positioned in a staggered arrangement, i.e. the secondary inlet 11 and outlet 13 manifolds of the first circuit are no longer substantially aligned along the first direction X. However, the first flow 10 is directed along the first direction X.

In addition, the secondary inlet 21 and outlet 23 manifolds of the second circuit are positioned in a staggered arrangement, i.e. the secondary inlet 21 and outlet 23 manifolds of the second circuit are no longer substantially aligned along the first direction X. However, the second flow 20 is directed along the first direction X.

Thus, in a view along the plane of FIG. 6, normal to the second direction Y, a secondary inlet manifold 11 of the first circuit is aligned along the first direction X with a secondary inlet manifold 21 of the second circuit, and reciprocally a secondary outlet manifold 23 of the second circuit is aligned along the first direction X with a secondary inlet manifold 13 of the first circuit.

As shown by the examples of circulation of the gas flow of FIG. 6, such a staggered structure makes it possible to connect a secondary inlet manifold 11 of the first circuit with at least two secondary outlet manifolds 13 of the first circuit and to divide the flow by two while limiting load losses. Similarly, the staggered structure makes it possible to connect a secondary inlet manifold 21 of the second circuit with at least two secondary outlet manifolds 23 of the second circuit and to divide the flow by two while limiting load losses.

The staggered structure also makes it possible to connect a secondary outlet manifold 13 of the first circuit with at least two secondary inlet manifolds 11 of the first circuit and to collect the flow from two secondary inlet manifolds 11 while limiting load losses. Similarly, the staggered structure also makes it possible to connect an outlet duct 23 of the second circuit with at least two inlet ducts of the second circuit and to collect the flow from two secondary inlet manifolds 21 while limiting load losses.

The exchanger 1 has a structure which is particularly suited to an embodiment by additive manufacturing method. A method for manufacturing the exchanger 1 can then be implemented, entirely or partially, by additive manufacturing, for example by a powder bed laser fusion technique.

Although this invention has been described with reference to specific exemplary embodiments, it is obvious that modifications and changes can be made to these examples without departing from the general scope of the invention as defined by the claims. In particular, individual features of the different embodiments illustrated/mentioned can be combined in additional embodiments. Consequently, the description and the drawing must be considered in an illustrative rather than a restrictive sense.

3. The heat exchanger as claimed in claim 2,
comprising at least a second secondary inlet manifold and/or a second secondary outlet manifold, the main corresponding manifold among the main inlet manifold and the main outlet manifold comprises a primary duct and at least two auxiliary ducts meeting in the primary duct,
each secondary inlet manifold and/or each secondary outlet manifold being connected to an auxiliary duct.

4. The heat exchanger as claimed in claim 1, wherein the first circuit comprises a plurality of secondary inlet manifolds and a plurality of secondary outlet manifolds configured such that at least one secondary inlet manifold communicates with at least two secondary outlet manifolds.

5. The heat exchanger as claimed in claim 1, wherein the secondary inlet manifold and the secondary outlet manifold of the second circuit are respectively configured so that the directions of flow of the second gas flow at the inlet and the outlet of the second circuit are substantially along the first direction.

6. The heat exchanger as claimed in claim 5,
wherein the at least one secondary inlet and outlet manifolds of the second circuit has a V-shaped section in a section along a plane orthogonal to the second direction.

7. The heat exchanger as claimed in claim 6, wherein walls of the V-shaped section have an angle with the first direction less than preferably less than 30°.

8. A turbomachine comprising a heat exchanger as claimed in claim 1.

9. The turbomachine as claimed in claim 8, wherein the first circuit is connected to a compressor and the second circuit is connected to a turbine.

10. A method for manufacturing a heat exchanger as claimed in claim 1, comprising at least one powder bed additive manufacturing step.
